(19) United States
(12) Patent Application Publication
(10) Pub. No.: US 2009/0084458 A1
(43) Pub. Date: Apr. 2, 2009

(54) Hose Assembly With Metal Wires Received Therein

(76) Inventor: Ting-I Lin, Chan-Hwa (TW)

Correspondence Address: LIN & ASSOCIATES INTELLECTUAL PROPERTY, INC., P.O. BOX 2339, SARATOGA, CA, 95070-0339, US

(21) Appl. No.: 11/866,252

(22) Filed: Oct. 2, 2007

(51) Int. Cl. F16L 11/12

(52) U.S. Cl. 138/128; 239/542; 138/124; 138/DIG. 8

(57) ABSTRACT

A hose assembly includes a hose with at least one metal wire received therein, and the metal wire can be bent to desired angles. The hose includes at least one seam which defines a plurality of small holes through a wall of the hose. The wall is made by water-proof material. By the metal wires, the hose can be bent to desired angles and shapes according to the paths of the garden, and the water flows out of the small holes to evenly water the plants and soil around the plants.

### BACKGROUND OF THE INVENTION

1. Field of the Invention

The present invention relates generally to a hose assembly with at least one metal wire received therein and a plurality of small holes are defined through the hose for watering plants. The at least one wire allows the hose to be bent as desired.

2. The Prior Arts

A conventional way to water plants generally uses a sprinkler or hose manually to let water be sucked by the soil around the plants such that the plants absorb water from the soil. However, the user has to water each plant and this requires a significant labor demand. When the hose is filled with water, the water pressure makes the hose stiff and movable. The movable hose might hit the plants and injure the sprouts or buds. Furthermore, lack of water source is a concern when watering plants.

Some people set hoses around the garden and holes are defined through the hoses so that when the water passes through the hose, the water flows out from the holes to water the plants. By this way, the users simply turn the faucets to water certain area of the gardens without too much labor. The other way is to set automatic sprinkling system which includes a main pipe buried in the soil and a plurality of nozzles are connected to the main pipe by sub-pipes which provides a water stream to hit the nozzles which pivots back and forth to send water to the area around the nozzle.

However, the water sprinkled from the nozzles may be blown away from the garden so that exceed water is needed. The range that the water is sprinkled is fixed and may be sprinkled on sidewalks or even the pedestrians. The exposed nozzles affect the aesthetic appearance of the garden. Besides, the system is costly and the nozzles cannot be removed. Some plants are tiny and weak and might be hurt by strong water stream by the system.

The present invention provides a hose assembly for watering plants and the hose of the present invention improves the shortcomings of the conventional watering systems and ways.

### SUMMARY OF THE INVENTION

According to the present invention, a hose assembly is provided and includes a hose with at least one metal wire received therein and the metal wire can be bent to desired angles. The hose has at least one seam which defines a plurality of small holes through a wall of the hose.

A main objective of the present invention is to provide a hose assembly for watering plants and the hose includes at least one metal wire received therein so that the hose can be bent to meet the path of the garden, and water flows out from the small holes to water the plants and the soil.

Another objective of the present invention is to provide a hose assembly, in which the hose can be bent to just water the area where the plants located, such that the amount of water can be controlled, and the hose does not move or shift to inject the plants especially the buds or sprouts.

Yet another objective of the present invention is to provide a hose assembly which is easily manufactured at low cost and the hose is flat when not in use. The flat hose can be coiled for easy store or carry.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a hose assembly in accordance with the present invention;

FIG. 2 is a perspective view showing a hose is inflated when water flows through the hose and water flows out from the small holes;

FIG. 3 shows that the hose can be bent to desired angles and shapes;

FIG. 4 shows that the hose can be coiled for store;

FIG. 5 shows that the hose includes two seams; and

FIG. 6 shows that the hose is bent according to the path of the garden.

### DETAILED DESCRIPTION OF THE PREFERRED EMBODIMENT

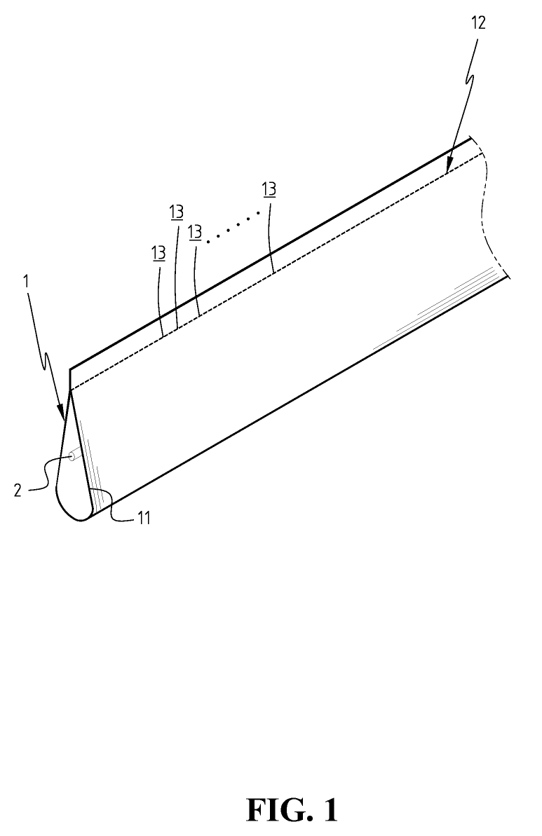

With reference to the drawings and in particular to FIG. 1, a hose assembly comprises a hose 1 with at least one metal wire 2 received therein and the metal wire 2 can be bent to desired angles. The hose 1 includes at least one seam 12 which defines a plurality of small holes 13 through a wall 11 of the hose 1. The small holes 13 are located linearly. The wall 11 of the hose 1 is a water-proof wall and can be made by non-woven fabric.

In order to enhance the stability of the hose assembly, the hose 1 may include two or more than three metal wires 2 received therein.

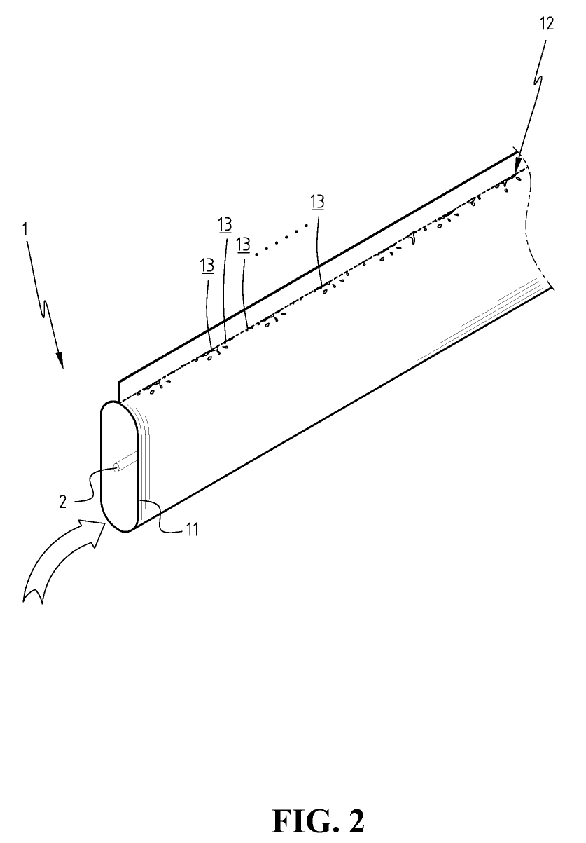

As shown in FIG. 2, the arrow shows the direction that water passes through the hose 1 and the water flows out from the small holes 13 through the wall 11. The small holes 13 are arranged linearly, and the number of the small holes 13 is large enough such that even if the water pressure in the hose 1 is high, the water just flows out from the small holes 13 rather than ejects to the air. By this way, water does not hurt the plants and is not wasted.

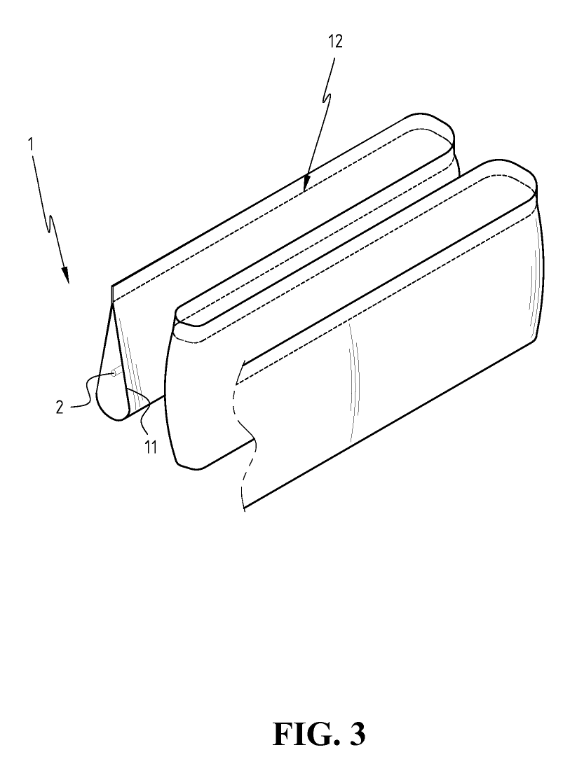

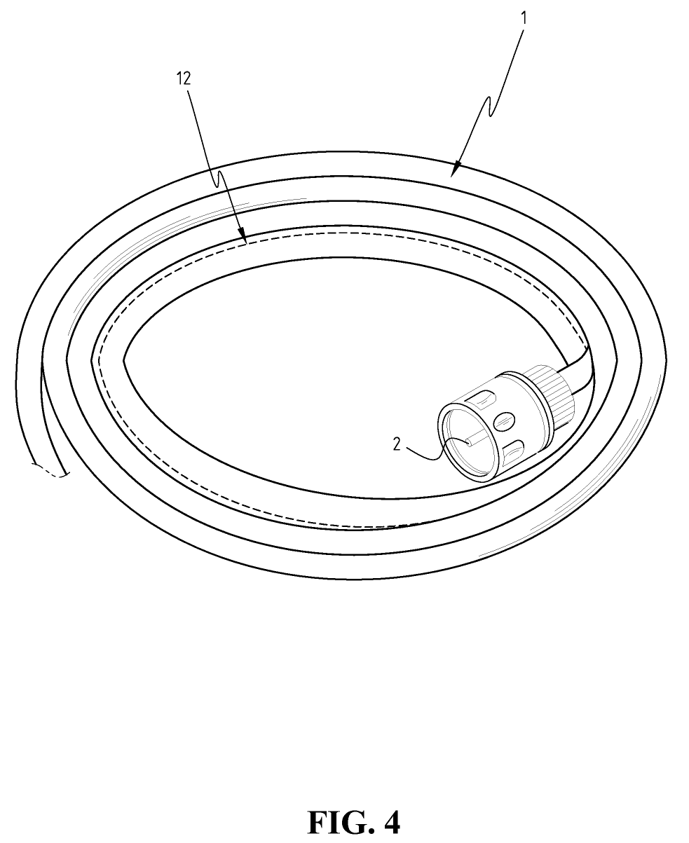

As shown in FIG. 3, by using the metal wire 2 in the hose 1, the hose 1 can be bent to be a specific shape such as an S shape. As shown in FIG. 4, when the hose 1 is not in use, it is a flat hose which can be easily coiled for store.

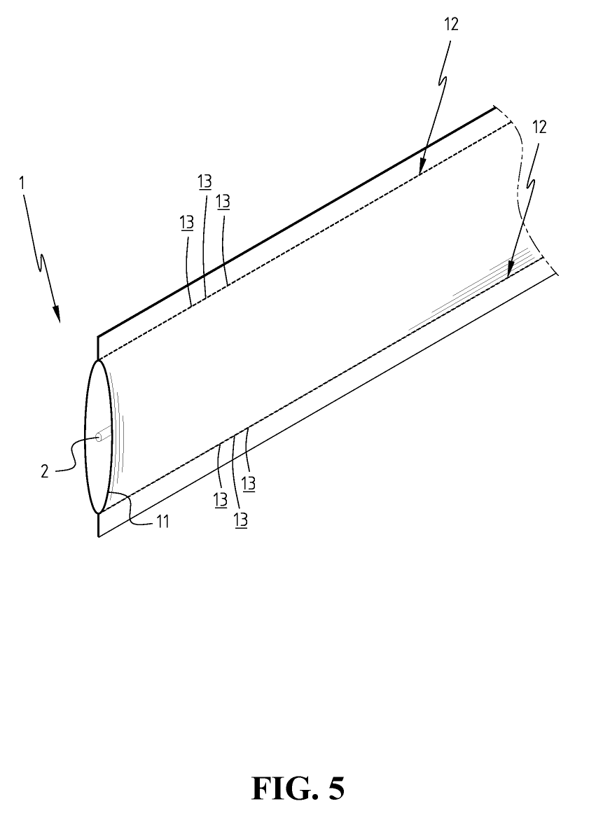

FIG. 5 shows a hose assembly in accordance with another embodiment of the present invention, in which the hose 1 includes two seams 12 and each seam 12 defines the small holes 13. The embodiment provides double amount of water out from the small holes 13 and meanwhile prevents water from ejecting from the small holes 13 in areas with high water pressure. The embodiment is suitable for larger area of watering.

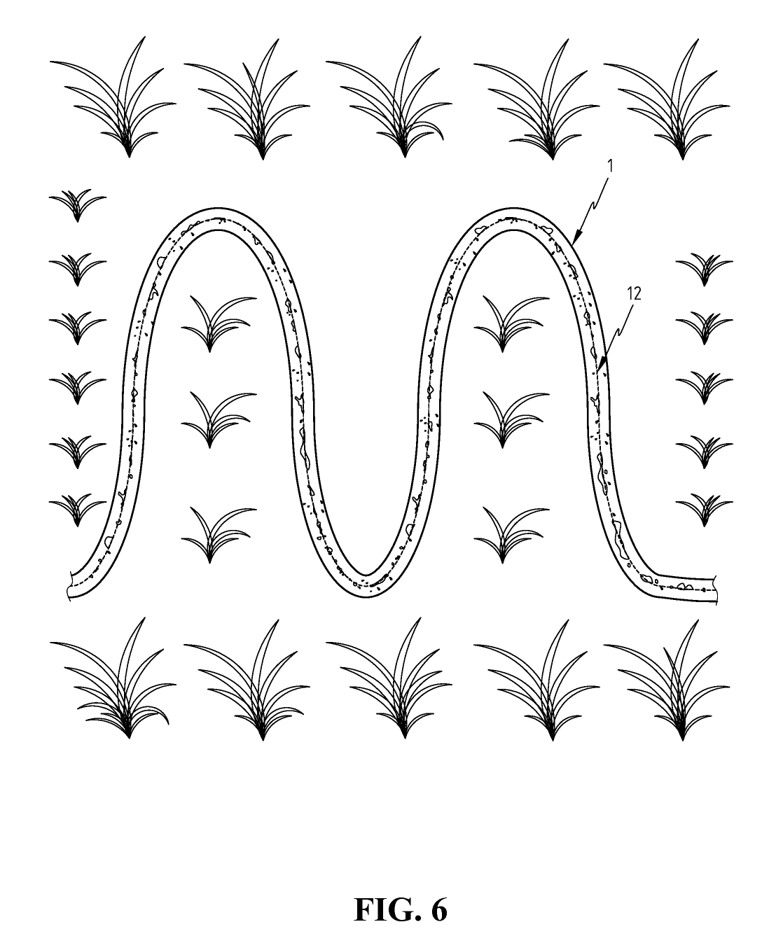

FIG. 6 shows that the hose 1 can be bent according to the path of the garden and water flows out from the small holes 13 to water the plants and soil.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A hose assembly, comprising:
a hose with at least one metal wire received therein and the metal wire being bent to desired angles, the hose having at least one seam which defines a plurality of small holes through a wall of the hose.

2. The hose assembly as claimed in claim 1, wherein the wall of the hose is a flexible and water-proof wall.

3. The hose assembly as claimed in claim 2, wherein the wall of the hose is made by non-woven fabric.

4. The hose assembly as claimed in claim 1, wherein the hose includes two seams to increase the quantity of the small holes and the amount of water out from the small holes.

5. The hose assembly as claimed in claim 1, wherein the hose includes two metal wires received therein to enhance the stability of the hose assembly.
